(19) United States
(12) Patent Application Publication
(10) Pub. No.: US 2008/0046577 A1
(43) Pub. Date: Feb. 21, 2008

(54) Distributing Content Data

(76) Inventors: Kit Temple, Surrey (GB); Mark Harrington, Fairfield, CT (US)

Correspondence Address: LUCAS & MERCANTI, LLP, 475 PARK AVENUE SOUTH, 15TH FLOOR, NEW YORK, NY, 10016, US

(21) Appl. No.: 10/541,090

(22) PCT Filed: Dec. 18, 2003
(86) PCT No.: PCT/EP03/51065

§ 371 Date: Sep. 14, 2007

(30) Foreign Application Priority Data
Dec. 30, 2002 (GB) 0230263.6

(51) Int. Cl. G06F 15/16; G07F 7/08

(52) U.S. Cl. 709/229

(57) ABSTRACT

A system for distributing various content data to user terminals having at least one application for interpreting the content data and presenting it to a user, the system including a multiplicity of individual tokens, each token bearing an identity code, and having a user-removable obscuring means obscuring reading of the identity code; a content server connected to a communication network whereby it may communicate with the terminals, and including data storage means storing the content data, and for each of the identity codes an indication of an item of the content data with which that code is associated, and indicated on the or each token bearing that code, and arranged to, on receiving from a terminal an identity code of a token, retrieve from the data storage means the item of content data associated with that code and transmit it to that terminal.

This invention relates to distributing content data to user terminals.

User terminals such as mobile phones, personal computers and PDAs (personal digital assistants) often support user applications that can interpret content data that can be supplied to the terminal by a user to provide the terminal with additional or alternative functionality. For example, a mobile phone may be able to interpret content data defining audio or video information, or may have an interpreter that can run software in a language such as Java. The audio or video information could be audio or video clips to be displayed and/or replayed on the phone, or a picture that can be used as virtual wallpaper to decorate the display of the phone. The software could provide a wide range of different functionalities, for instance a new game, a screensaver or a new application such as an e-mail reader or a web browser.

Data of this type can be distributed in a number of ways. First, pre-recorded media bearing the content data can be distributed to users of the terminals, who can then load the content data locally on to the terminals. This is the case, for example, with the distribution of data on pre-recorded CDs. This method has the advantage that users can buy the pre-recorded media in a traditional physical shopping transaction. Alternatively, the content data can be made available through a network such as the internet, and users can then pay for the content data on-line and download it to their terminals. This method has the advantage that there is no need to physically distribute media carrying the data, which saves on distribution costs. However, some users are resistant to on-line shopping, as it may be unfamiliar to them and is viewed by some as being insecure.

It would be desirable to have a means of distributing content data to terminals that addressed these problems.

According to the present invention there is provided a system for distributing various content data to user terminals having at least one application for interpreting the content data and presenting it to a user, the system comprising: a multiplicity of individual tokens, each token bearing an identity code, and having a user-removable obscuring means obscuring reading of the identity code; a content server connected to a communication network whereby it may communicate with the terminals, and comprising data storage means storing the content data, and for each of the identity codes an indication of an item of the content data with which that code is associated, and indicated on the or each token bearing that code, and arranged to, on receiving from a terminal an identity code of a token, retrieve from the data storage means the item of content data associated with that code and transmit it to that terminal.

Preferably each token is in the form of a card. Alternatively, it may be in the form of any other suitable object.

Preferably the user-removable obscuring means is such as to be irreversibly removable. The user-removable obscuring means may suitably be a scratch-off coating or an envelope.

The content data could include, but is not limited to, any one or more of the following: software defining a game, attributes of a gaming entity, unlock codes, software (e.g. Java, BREW or Symbian), pictures, audio clips, video clips, multimedia clips, utilities, ring tones or other alerting configurations, virtual wallpaper and screensavers. The token preferably bears a visible indication of an item of content data or a group of items of content data.

Preferably each identity code is different from all the other identity codes. Most preferably the content server stores for each identity code an indication of whether content associated with that code has been transmitted to a terminal, and the content server is arranged to on receiving from a terminal an identity code of a token, transmit to that terminal the item of content data associated with that code only if the indication stored for that code indicates that content associated with that code has not been transmitted to a terminal.

Preferably at least some of the tokens are an individual vending items in their state when the code is obscured by the obscuring means. This is the case if each such token is on sale individually. Preferably the tokens are made available by their sale to the public. The tokens could be sold in groups, for example in packs of five.

Preferably at least some of the terminals are wireless communication terminals, for instance mobile phones. The application could be a Java platform.

Preferably each token bears an indication of the content data associated with the code borne by the token. Preferably each token bears an indication of the retail price of the token. If the token is in the form of a card contained within an envelope, the envelope constituting the obscuring means, the price is preferably marked on the envelope.

According to a second aspect of the present invention there is provided a method for distributing various content data to user terminals having at least one application for interpreting the content data and presenting it to a user, the method comprising: making available a multiplicity of individual tokens, each token bearing an identity code, and having a user-removable obscuring means obscuring reading of the identity code; storing in data storage means of a content server connected to a communication network whereby it may communicate with the terminals the content data, and for each of the identity codes an indication of an item of the content data with which that code is associated; and on receiving at the content server from a terminal an identity code of a token, retrieving from the data storage means the item of content data associated with that code and transmitting it to that terminal.

The transmitted content data may be stored at the terminal.

The terminal preferably interprets the transmitted content data and presents it to a user of the terminal. The presentation of the data may be done directly, for example by its display or play out to the user, or indirectly, for example by following the instructions or attributes defined in the data so as to present resulting consequences to the user.

The present invention will now be described by way of example with reference to the accompanying drawing.

In the drawing:

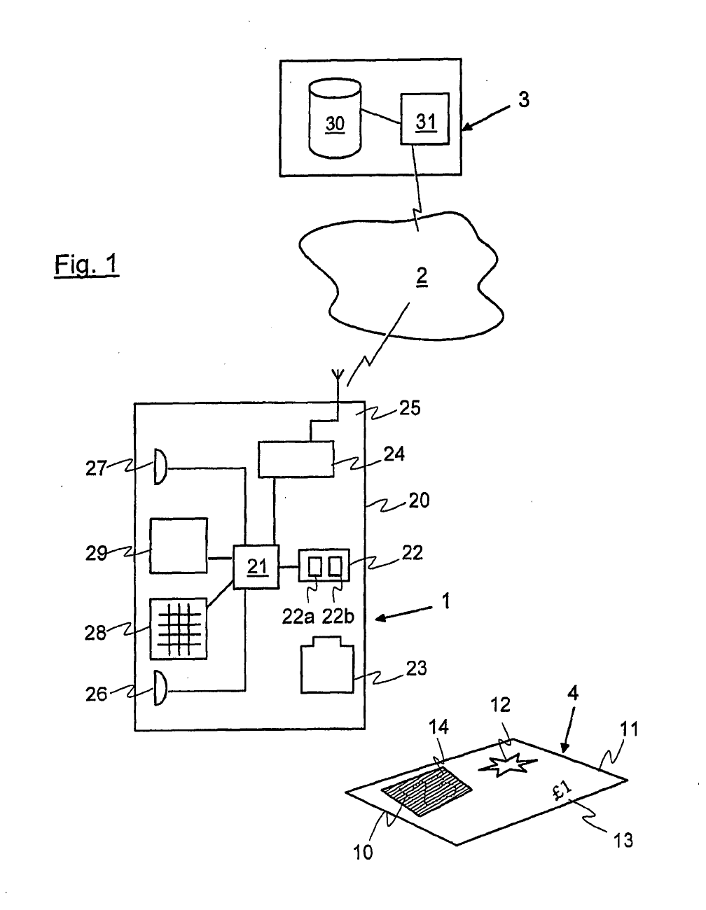

FIG. 1 is a schematic cross-section of a first electronic device, a communications system and a card.

FIG. 1 shows a mobile phone 1, a communication network 2, a content server 3 and a card 4.

The card is one of a multiplicity of similar cards. Each of those cards has a unique code number 10 printed on it, which does not appear on any of the other cards. A user can buy the card in a conventional physical purchase. The content server stores content data that can be interpreted by terminals. Examples of the types of content data that could be stored by the content server are given in more detail below. The content server also stores a mapping for each of the unique code numbers, mapping it on to one of the items of content data. A user of the mobile phone 1 can cause it to connect over the network 2 to the content server 3. Once such a connection has been established the user can enter into the mobile phone the code number on a card in his possession, and cause the phone to transmit that to the content server 3. The content server is configured so that in response to receiving a code number from a terminal it returns to that terminal the content data to which that code number is mapped.

In this way, a user can purchase a card in a physical transaction, and thereby gain access to a code number that can be used to obtain the content data. This has the advantage that at least some users may be more comfortable with buying on-line content in this way than by buying it on-line. The card may also have other functions, as described in more detail below. For example, it may be part of a collectible series, or it may provide information that can be used in a game. The card can thus provide a new way of providing such combined functionality to users.

The content server 3 includes a data store 30, which holds the content data and a processor 31 which performs the processing to authenticate codes and transmit the appropriate content data to requesting terminals. The content server could be a single physical unit or could be physically distributed.

The network 2 could be the internet and/or a mobile phone network.

The mobile phone of FIG. 1 comprises a housing 20 which contains a control processor 21, a memory 22, a battery 23, a radio transceiver unit 24, an antenna 25, a microphone 26, a loudspeaker 27, a keypad 28 and a display 29. In operation of the phone, the electrical components of the phone are powered by the battery 23. The control processor 21 performs application-related processing under the control of programme instructions stored in memory 22. The radio transceiver unit 24 receives signals from antenna 25, processes them to determine the data represented therein and passes that data to the control processor for subsequent processing. Data to be transmitted is passed to radio transceiver unit 24 by the control processor and appropriate signals are then transmitted by means of the antenna. A user's voice can be picked up by microphone 26 which provides input to the control processor to form data for transmission. Received audio data can be played through the loudspeaker 27. A user can provide input to the control processor by means of keypad 28. The control processor can control the display 29 to display user data such as locally composed messages, messages received via the radio transceiver unit, dialled telephone numbers, telephone numbers from which incoming calls have originated, and messages indicating the status of the mobile phone.

The memory 22 includes a non-volatile memory 22a and a random access memory (RAM) 22b. The non-volatile memory includes instructions defining applications for interpreting content data loaded into the RAM or the user-accessible section of the non-volatile memory. These instructions will vary depending on the type of content that is supported. The non-volatile memory also includes instructions for supporting a routine for downloading content data into either the RAM or into the user-accessible section of the non-volatile memory. This may, for example be a web browser application, or a dedicated application using Java, for instance. Alternatively, the code and the content data may be carried using short message service (SMS) messages or the like.

Some examples of the forms that the content data could take, and the applications that could be used on the phone to interpret the content data are as follows.

| Content data | Application |
|---|---|
| Pictures and audio and video clips, | Media player |
| multi-media messaging system (MMS) | |
| images | |
| HTML pages, news articles, share | Web browser or other text or |
| prices, horoscopes | multimedia interpreter |
| E-books | E-book reader |
| Java or other applets (e.g. games, | Java or other interpreter |
| calendars and utilities) | |
| Pictures | Photo viewer |
| Ring tones, wallpaper, screensavers | Phone operating system |
| and other phone-level operating | |
| functionality | |
| Unlock codes (e.g. for unlocking levels | Game software, running on |
| and characters or crediting characters | phone operating system or |
| in games already stored on the phone) | intermediate interpreter |

The card 4 comprises a substrate 11 of cardboard or plastics material. The card is conveniently credit-card or playing-card sized. The card is printed with markings 12 to indicate the type of the card, and to provide instructions on its use. The retail price 13 may also be marked on the card. When the card is manufactured, it is printed with the unique code number 10. Then the code number is obscured so that it cannot be read. The obscuring of the number is done in such a way that the number can later be rendered legible, most preferably in an irreversible way, by someone who has access to the card. For example, the number could be covered by opaque scratch-off foil 14, or the card could be encapsulated in an opaque envelope. Other forms of token than such cards could be used.

The issuing of the code numbers, by their printing on to cards and the issuance of those cards to the public, is synchronised with the activation of those numbers by their mapping on to content at the content server.

The cards can be issued to the public by being put physically on sale in shops, kiosks etc.

The content server stores a record for each unique number of whether it has been used to obtain content data. This prevents a number from being used twice to fraudulently download content to two different terminals. Alternatively, an identification code of a terminal or a user of the terminal may be stored for each unique number when content is downloaded. Then the number could be re-used, but the server would check the identification code of the terminal or user re-using the number and only allow the content to be downloaded to the same user and/or terminal as downloaded it before.

In operation, a user visits a shop and selects a card that is printed with an indication of the content that the user wants to purchase. This could, for instance, be a game, a game character, a game level or a book. The precise nature of the content could be specified visibly at the point of sale, or the card could just indicate a general type of content data, and the user could discover the precise content only on revealing a part of the card that is obscured at the point of sale (e.g. by an envelope, and preferably by obscuring means distinct from that which obscures the code) or on downloading and activating the content. The user buys the card and renders the unique code number visible. Using the download application on the user's phone he contacts the content server 3 over the network 2. He inputs the code number using the keypad 28 of the mobile phone and the download application transmits it to the content server. The content server verifies that the code number has not previously been used. Provided it has not been used, the content server determines the content data on to which the code number is mapped, and transmits it to the users terminal. It also marks the code number as having been used. The user's terminal receives the content data and determines its type. This may be done from a header in the content data, or from the file name of the content data. Based on the determined type of the data the terminal stores the content data in an appropriate place, for instance in non-volatile memory 22a. The content data is then available for use by the appropriate application in the phone.

The cards may have other functions than serving as a vehicle for the unique code number. For instance, it may serve as a gaming card. Many cards are sold for use in children's games, for example collecting, trading or swapping games. The card may be printed with material making it suitable for use in such a game. This may include an indication of a real or imaginary character or other collectable entity (e.g. a vehicle), and/or information on the attributes of that character or entity and/or authentication information to prove that the card is genuine. Then the card can serve for use in such a game in addition to making the content data available to the owner of the card. The content data made available by the number on the card may be linked to the character or entity depicted on the card.

In one preferred embodiment, the application that interprets the content data may be an application for wireless gaming, which makes use of the wireless communication capabilities of the mobile phone. For instance, the cards could depict characters or entities, as described above, and the content data could represent supposed attributes of the character or entity depicted on the card or attributes of a player in the game. The application could exchange one or more of the attributes with those stored similarly on another terminal, and the applications on each terminals could then determine which of the users of the terminals is the winner based on an analysis of the exchanged attributes according to a predetermined algorithm.

The code number may be replaced by other forms of unique identity. For instance, it could include letters and/or symbols, or it could be in a machine readable form (for instance a bar code or a magnetic stripe) if that could be read by the phone. The code could be non-unique, and the server could permit numerous downloads to multiple users using the same code. However, this is less preferred as it is likely to result in users copying codes instead of buying the cards to obtain them.

The system described above is not limited to use with a mobile phone as the terminal. For example, the terminal could instead be a personal computer or a personal digital assistant (PDA). The terminal is preferably, but not necessarily, capable of wireless communication with a communication network.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A system for distributing various content data to user terminals having at least one application for interpreting the content data and presenting it to a user, the system comprising:
a multiplicity of individual tokens, each token bearing an identity code, and having a user-removable obscuring means obscuring reading of the identity code;
a content server connected to a communication network whereby it may communicate with the terminals, and comprising data storage means storing the content data, and for each of the identity codes an indication of an item of the content data with which that code is associated, and indicated on the or each token bearing that code, and arranged to, on receiving from a terminal an identity code of a token, retrieve from the data storage means the item of content data associated with that code and transmit it to that terminal.

2. A system as claimed in claim 1, wherein each token is in the form of a card.

3. A system as claimed in claim 1, wherein the user-removable obscuring means is such as to be irreversibly removable.

4. A system as claimed in claim 3, wherein the user-removable obscuring means is a scratch-off coating.

5. A system as claimed in claim 1, wherein the content data includes software defining a game and/or attributes of a gaming entity.

6. A system as claimed in any preceding claim 1, wherein the content data includes Java software.

7. A system as claimed in claim 1, wherein each identity code is different from all the other identity codes, the content server stores for each identity code an indication of whether content associated with that code has been transmitted to a terminal, and the content server is arranged to on receiving from a terminal an identity code of a token, transmit to that terminal the item of content data associated with that code only if the indication stored for that code indicates that content associated with that code has not been transmitted to a terminal.

8. A system as claimed in claim 1, wherein each token is an individual vending item.

9. A system as claimed in claim 1, wherein at least some of the terminals are wireless communication terminals.

10. A system as claimed in claim 1, wherein each token bears an indication of the content data associated with the code borne by the token.

11. A system as claimed in claim 1, wherein each token bears an indication of the retail price of the token.

12. A method for distributing various content data to user terminals having at least one application for interpreting the content data and presenting it to a user, the method comprising:
making available a multiplicity of individual tokens, each token bearing an identity code, and having a user-removable obscuring means obscuring reading of the identity code;
storing in data storage means of a content server connected to a communication network whereby it may communicate with the terminals the content data, and for each of the identity codes an indication of an item of the content data with which that code is associated; and
on receiving at the content server from a terminal an identity code of a token, retrieving from the data storage means the item of content data associated with that code and transmitting it to that terminal.

13. A method as claimed in claim 12, comprising storing the transmitted content data at the terminal.

14. A method as claimed in claim 12, comprising interpreting the transmitted content data at the terminal and presenting it to a user of the terminal.

15. A method as claimed in claim 12, comprising selling the tokens individually so as to make them available.

16. A method as claimed in claim 12, comprising selling the tokens in packs of such tokens so as to make them available.

17. (canceled)

18. (canceled)
